(19) United States
(12) Patent Application Publication
(10) Pub. No.: US 2015/0370437 A1
(43) Pub. Date: Dec. 24, 2015

(54) AUTOMATED EMAIL DOCUMENT STORAGE SYSTEMS AND METHODS

(71) Applicant: Mesa Digital, LLC, Albuquerque, NM (US)

(72) Inventors: Luis M. Ortiz, Albuquerque, NM (US); Kermit D. Lopez, Albuquerque, NM (US)

(73) Assignee: Mesa Digital, LLC.

(21) Appl. No.: 14/741,714

(22) Filed: Jun. 17, 2015

Related U.S. Application Data
(60) Provisional application No. 62/013,658, filed on Jun. 18, 2014.

(51) Int. Cl. G06F 3/0484; H04L 12/58

(52) U.S. Cl. CPC G06F 3/0484; H04L 51/22

(57) ABSTRACT

An email client includes a user interface that provides a STORE field in addition to TO, CC, BCC, SUBJECT, SENDER, and message body fields. The STORE field can be used to select a storage location for the email message and any attachments that is besides or in addition to the SEND file location associated with the email client. Email messages can be automatically stored once a user sends a message. The email message can also be converted into another format prior to storage after the message is sent by a user to email recipients.

### INVENTION PRIORITY

The present application claims priority as a continuation of provisional patent application Ser. No. 62/013,658, filed on Jun. 18, 2014 for the invention entitled “Automated Email Document Storage Systems and Methods”, which is hereby incorporated by reference in its entirety.

### FIELD OF THE INVENTION

Embodiments are related to email software client applications and electronic messaging. More particularly, embodiments relate to systems and methods enabling the automatic storage of email messages at a user-selected storage location automatically when the email message is sent from an email client.

### BACKGROUND

Email is widely used for business and personal use. Email message are automatically stored in a “SENT” folder associated with most email client applications once an email message is sent. The SENT folder stores all sent email messages in a single folder associated with the email client software: however, users often need to archive sent email messages in another location, outside of the email client. This is often the case in the legal and business fields where a record of correspondence sent to third parties, customers or clients must be organized and stored in a folder associated with a particular case, party or matter so that it can easily be retrieved if and when it is needed at a later date. It is also important that any attachments associated with an email correspondence be stored with the message.

In order to store important email messages in a particular folder associated with a party or matter, a user must locate the sent message in the SENT folder of the email client and copy or move it into an folder or storage location associated with the party or matter that may already be set up and located on a hard drive, server, cloud-based location, etc. The email message might be converted into PDF format before it is archived in the party- or matter-specific folder. A user must therefore engage in several steps to achieve storage of important email correspondence. What is needed are methods and systems that reduce the number of steps and effort required to locate sent email messages in an email client's general SAVE folder and save them in a memory location (e.g., folder) that is uniquely associated with the message.

### SUMMARY

The present invention provides systems and methods that enable the automatic storage of email messages at a user-selected storage location automatically when an email message is sent from an email client. In accordance with a feature of the present invention, an email client includes a “STORE” field in addition to the typical “TO”, “CC”, “BCC”, and “SUBJECT” fields that generally comprise the header portion of an email message in an email client user interface.

In accordance with features of the present invention, a user can select and/or create any folder location typically accessible by the user's computer from the “STORE” field of the email client for automatic storage of the email message and its attachments once the user sends a message by selecting the “SEND” button typically provided on the email client user interface.

In accordance with another feature of the present invention, the improved email client with a “STORE” field can also automatically convert the email message into another file format, such as PDF, for ease of use by parties that may not have a compatible email client or reader software.

In accordance with another feature of the present invention, a user opens an email client from a computer and writes a message in the message field of the email message user interface. The user can attach documents, select addressees for the email message from any of the “TO”, “CC” and “BCC” fields, and can provide a subject for the email in the “SUBJECT” line. The user can also select a particular sending email address from a “FROM” field in the client, which is usually provided when a user has several email addresses associated with the email client. With the addition of a “STORE” field in an improved email client in accordance with teaching of the present invention, the user can also select a storage location were the email message can automatically be stored once a user sends the message, which is accomplished when the Send button is selected/pressed by the user. With an optional FORMAT selection field, a user can have the message converted into another file format. With the addition of an optional ENCYRPT selection feature, a user can also encrypt the message and any attachments during the message sending and automated storage process described herein.

### BRIEF DESCRIPTION OF THE DRAWINGS

FIG. 1, labeled as “prior art,” illustrates a screen shot of a typical user interface associated with an email client;

FIG. 2 illustrates a screen shot of a user interface that includes “STORE” and “ENCRYPT” fields in accordance with an improvement provided by embodiments of the present invention;

FIG. 3, a system diagram is illustrated in accordance with features of the disclosed embodiments;

FIG. 4 illustrates a flow diagram for a method in accordance with features of the disclosed embodiments; and

FIG. 5 illustrates a flow diagram for a method in accordance with features of the disclosed embodiments.

### DETAILED DESCRIPTION

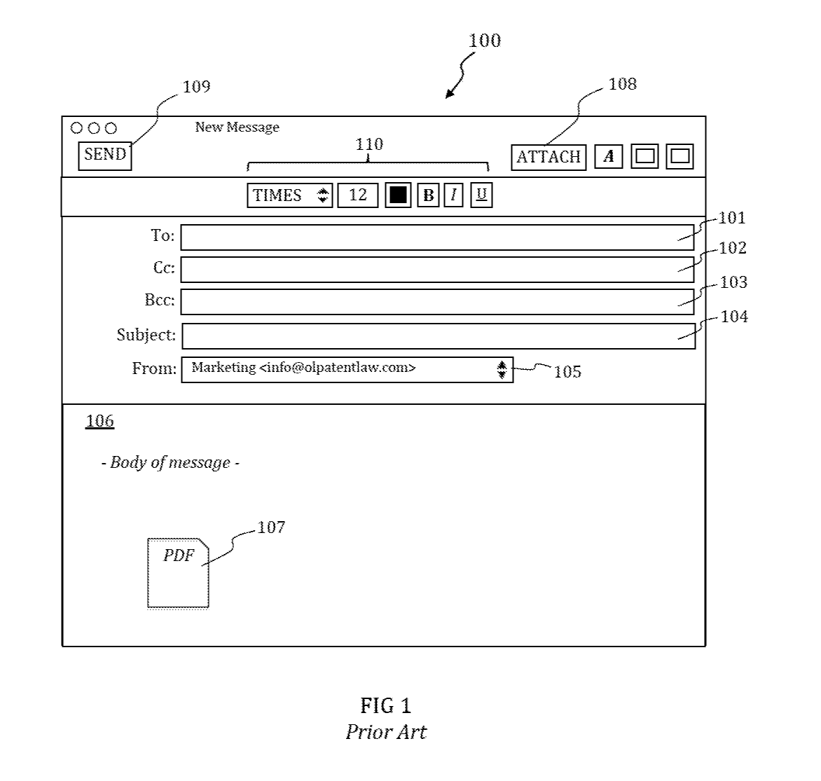

Referring to FIG. 1, a prior art representation of a user interface 100 associated with a typical email client is illustrated. The user interface includes a TO field 101, Cc field 102, Bcc field 103, Subject field 104, From field 105, and a message body 106. A user interface will also typically have means to attach documents 107 to the message by pressing an attachment button 108. An email message, once completed, can be sent when a user selects the SEND button 109. A user interface can also have editorial/style tools 110 for accomplishing text bolding, italicizing, underlining, font selection, and font size features.

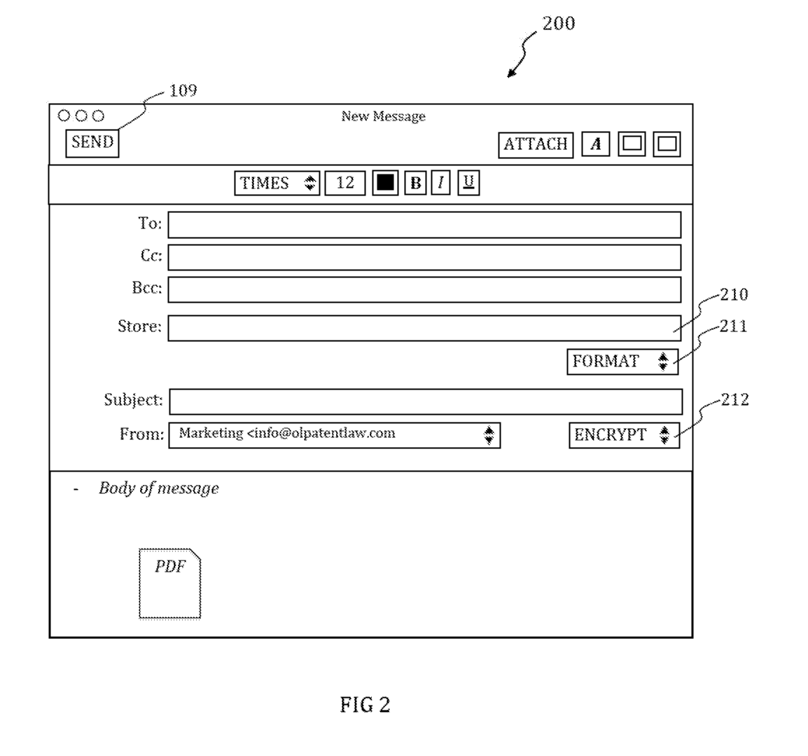

Referring to FIG. 2, an improved user interface 200 associated with an email client in accordance with features of the disclosed embodiments is presented. The user interface 200 can include all the features described and shown with respect to FIG. 1, with the additional feature of a STORE field 210. A user can access storage resources external to the email client from the STORE field 210. Selecting the STORE field 210 can engage the file explorer process available with most computer operating systems, wherein folders can be created, managed, and located. Just as the TO, Cc, and Bcc field enables a user to find and select an addressee for the message, the STORE field can enable a user to locate or create a folder location, during message creation, for automatic storage of the email message once sent from the email client. Also shown in FIG. 2 is a FORMAT button 211, which can be provided with the improved email client for a user to select a storage format for the email message when the STORE feature of the email client is used. Format options can be selected using the up-down scroll feature available with most operating systems. An email message can therefore be converted into a different format (e.g., none, PDF, .doc, .rtx, .txt, .htm) for storage purposes. If converted, the email client can store the email message in association with any attachments that may have been sent with the email message. The STORE feature can also simply store the email message with, for example, embedded attachments using the email client file format, or hypertext link using web format (.htm) to associated files. An optional ENCRYPT selector button 212 can also be provided to enable a user to encrypt the message prior to transmission and storage once the SEND button 109 is selected.

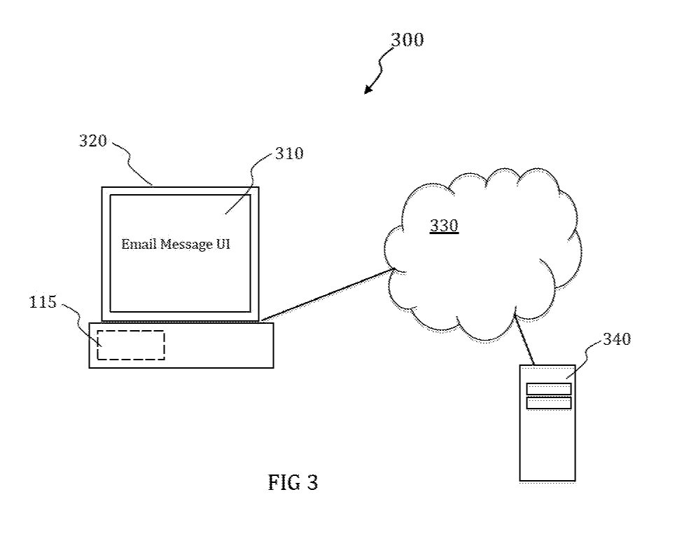

Referring to FIG. 3, a system diagram 300 is illustrated in accordance with the disclosed embodiments. An email client 310 in accordance with features of the present invention can be stored as software on a computer 320. The computer can be connected to a data network 330 through which it sends and receives email messages, and through which remote storage locations can be accessed such as a server 340. Email data (messages) can be stored on the computer 320 or the remote server 340. Email data in the form of sent messages is typically stored automatically in a SENT folder associated with the email client. The SENT folder can be associated with the email client at the computer 320 or the remote server 340. Email data can also be automatically stored after a message is sent in file locations set up separately on the computer 320 and/or remote server 340 from folders associated with the email client 310 utilizing features of the present invention.

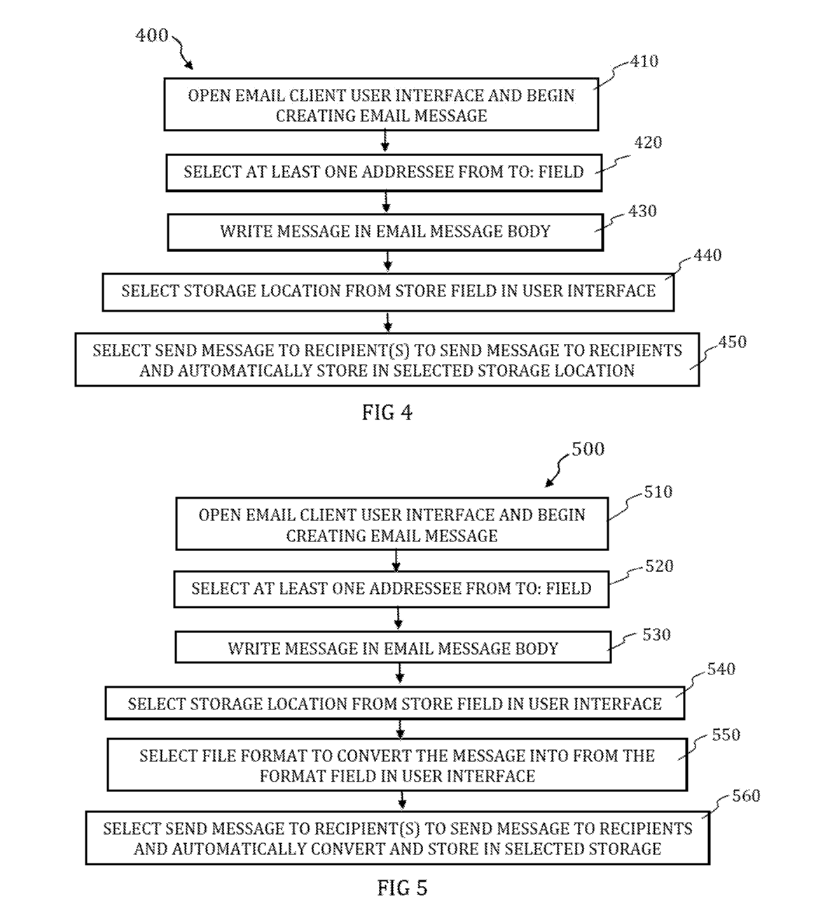

Referring to FIG. 4, a high level flow chart of operations of a method 400 of using an email client to automatically store a message into a user-selected folder upon sending of the email message is illustrated, in accordance with a preferred embodiment. As indicated at block 410, a user begins creating an email message by opening a user interface for an email client. As depicted at block 420, the user selects at least one addressee from a TO field. Next, as described at block 430, the user writes a message in a message body of an email client user interface. The user can then select or create a storage location from a STORE field of the user interface as shown at block 440. Thereafter, as illustrated at block 450, the message is sent to recipients (addressees) and can also be automatically stored in a location chosen by the user in the STORE field. It should be appreciated that a user may set up a folder initially within the email client, similar to selecting an email recipient for the first time, and once the folder location is created it can be remembered by the email client just as known email recipients are recognized once a user begins typing in an email recipients name. The autocomplete feature can suggest file locations with similar names and the user can select the proper location from the list by scrolling over the appropriate folder location. This feature is helpful in assisting user with quickly finding commonly used folder locations using the improved email client. Additionally, the client can be configured to automatically associate email recipients with storage folder locations, which can be suggesting prior to any typing by the user if the STORE field is selected by the user.

Referring to FIG. 5, a high level flow chart of operations of a method 500 is illustrated for a process of using an email client to automatically store a message into a user-selected folder upon sending of the email message is illustrated, in accordance with an alternative embodiment. As indicated at block 510, a user begins creating an email message by opening a user interface for an email client. As shown at block 520, the user selects at least one addressee from a TO field. Next, as described at block 530, the user can write a message in a message body of an email client user interface. Then, the user can select a storage location from a STORE field of the user interface as depicted at block 540. As illustrated at block 550, a user can also select a file format to convert the message into from the FORMAT field of the user interface. Thereafter, as illustrated at block 560, the message can be sent to recipients (addressees) and can also automatically be converted into another file format and then stored in a location chosen by the user in the STORE field. An additional step can be implemented into the process wherein encryption is selected for a message from the email client.

It can be appreciated that rules can be set up in a email client to accomplish file conversion, set up short cuts to specific files for storing messages, and converting messages into different file formats. The client can also be set up to covert an email message with attachments into a format that enables active hyperlinks to attachments that make up part of the archived message. Automatic hyperlinking can be established in order to maintain sent message association with its attachments and to facilitate ease of use by parties that a message may be shared with at a later time.

Note that in the description herein, for purposes of explanation, numerous specific details are indicated in order to provide a thorough understanding of the technology described. It should be apparent, however, that this technology can be practiced without these specific details. In other instances, structures and devices are shown in block diagram form in order to avoid obscuring the technology. For example, the present technology is described with some implementations below, with reference to user interfaces and particular hardware. However, the present technology applies to any type of computing device that may receive data and commands, and any devices providing services.

Moreover, the present technology is described above primarily in the context of creating and providing efficient email storage and archiving; however, the present technology may apply to any type of email usage and other applications beyond just e-mail interfaces.

Some portions of the detailed descriptions above are presented in terms of algorithms and symbolic representations of operations on data bits within a computer memory of either one or more computing devices. These algorithmic descriptions and representations (e.g., discussions and figures of an e-mail client interface) are the means used in the data processing arts to most effectively convey the substance of their work to others. An algorithm as indicated here, and generally, is conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be understood, however, that all of these and similar terms are to be associated with the appropriate physical quantities and are merely convenient labels applied to these quantities. Unless specifically stated otherwise, as apparent from the following discussion, it should be appreciated that throughout the description, discussions utilizing the terms “processing,” “computing,” “calculating,” “determining,” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission, or display devices.

The present technology also relates to an apparatus for performing the operations described here. This apparatus may be specially constructed for the required purposes, or it may include a general-purpose computer selectively activated or reconfigured by a computer program stored in the computer. Such a computer program may be stored in a computer-readable storage medium, for example, but not limited to, any type of disk including floppy disks, optical disks, CD-ROMs, magnetic disks, read-only memories (ROMs), random access memories (RAMs), EPROMs, EEPROMs, magnetic or optical cards, flash memories including USB keys with non-volatile memory or any type of media suitable for storing electronic instructions, each coupled to a computer system bus.

This technology may take the form of an entire hardware implementation, an entire software implementation, or an implementation including both hardware and software components. In some implementations, this technology is implemented in software, which includes, but is not limited to, firmware, resident software, microcode, etc.

Furthermore, this technology may take the form of a computer program product accessible from a computer-usable or computer-readable medium providing program code for use by or in connection with a computer or any instruction execution system. For the purposes of this description, a computer-usable or computer-readable medium may be any apparatus that may include, store, communicate, propagate, or transport the program for use by or in connection with the instruction execution system, apparatus, or device.

A data processing system suitable for storing and/or executing program code includes at least one processor coupled directly or indirectly to memory elements through a system bus. The memory elements may include local memory employed during actual execution of the program code, bulk storage, and cache memories, which provide temporary storage of at least some program code in order to reduce the number of times code must be retrieved from bulk storage during execution.

Input/output or I/O devices (including but not limited to keyboards, displays, pointing devices, etc.) may be coupled to the system either directly or through intervening I/O controllers.

Communication units including network adapters may also be coupled to the systems to enable them to couple to other data processing systems, remote printers, or storage devices, through either intervening private or public networks. Modems, cable modems, and Ethernet cards are just a few examples of the currently available types of network adapters.

The algorithms, methods, systems, and displays presented in this application are not inherently related to any particular computer or other apparatus. Various general-purpose systems may be used with programs in accordance with the teachings here, or it may prove convenient to construct more specialized apparatus to perform the required method steps. The required structure for a variety of these systems is outlined in the description above. In addition, the present technology is not described with reference to any particular programming language. It should be understood that a variety of programming languages may be used to implement the technology as described here.

The foregoing description of the implementations of the present technology has been presented for the purposes of illustration and description. It is not intended to be exhaustive or to limit the present technology to the precise form disclosed. Many modifications and variations are possible in light of the above teaching. It is intended that the scope of the present technology be limited not by this detailed description, but rather by the claims of this application. As should be understood by those familiar with the art, the present technology may be implemented in other specific forms, without departing from the spirit or essential characteristics thereof. Likewise, the particular naming and division of the modules, routines, features, attributes, methodologies, and other aspects are not mandatory or significant, and the mechanisms that implement the present disclosure or its features may have different names, divisions, and/or formats. Furthermore, as should be apparent, the modules, routines, features, attributes, methodologies, and other aspects of the present technology can be implemented as software, hardware, firmware, or any combination of the three. Also, wherever a component, an example of which is a module, of the present technology is implemented as software, the component can be implemented as a standalone program, as part of a larger program, as a plurality of separate programs, as a statically or dynamically linked library, as a kernel loadable module, as a device driver, and/or in every and any other way known now or in the future to those in the art of computer programming. Additionally, the present technology is in no way limited to implementation in any specific programming language, or for any specific operating system or environment. Accordingly, the disclosure of the present technology is intended to be illustrative, but not limiting, of the scope of the present disclosure, which is set forth in the following claims.

What is claimed is:

1. An email client comprising a user interface, including:
a TO field, wherein at least one recipient of an email message is selectable by an email client user;
a SUBJECT field, wherein a subject for the email message is identifiable by the email client user;
a message body, wherein text of the email message is entered by the email client user;
a send button; and
a STORE field, wherein a memory location the email message can be stored is identifiable and selectable by the email client user for storage of the email message when the user sends the email message by selecting the send button.

2. The email client of claim 1, further comprising a FORMAT button, wherein a file format for automatic conversion of the email message into a format for storage is selectable by the email client user when the STORE field is used.

3. The email client of claim 2, wherein the format includes at least one of: PDF, .doc, .rtx, .txt, and .htm.

4. The email client of claim 1, further comprising an ENCYRPT button for selection of an encryption feature by the email client user, wherein the email message and any attachments are automatically encrypted when the send button is selected by the email client user.

5. The email client of claim 1, further comprising a CC and BCC button wherein additional email recipients can be selected for receipt of the email message when it is sent.

6. The email client of claim 2, further comprising an ENCYRPT button for selection of an encryption feature by the email client user, wherein the email message and any attachments are automatically encrypted when the send button is selected by the email client user.

7. The email client of claim 4, further comprising a FORMAT button, wherein a file format for automatic conversion of the email message into a format for storage is selectable by the email client user when the STORE field is used.

8. The email client of claim 7, wherein the format includes at least one of: PDF, .doc, .rtx, .txt, and .htm.

9. The email client of claim 6, further comprising a CC and BCC button wherein additional email recipients can be selected for receipt of the email message when it is sent.

10. The email client of claim 7, further comprising a CC and BCC button wherein additional email recipients can be selected for receipt of the email message when it is sent.

11. A method for archiving email messages in user-selected storage locations, comprising:
opening an email client from a computer;
entering a message in a message field of an email message user interface associated with the email client;
selecting at least one recipient for the email message from at least one of TO, CC, and BCC fields provided in the email user interface;
entering a subject for the email message in a SUBJECT field provided in the email user interface;
selecting a storage location via the email user interface to automatically store the email message upon sending the email message by selection of a send button on the email user interface; and
sending the email message to the at least one recipient and automatically storing the email message in the storage location that was selected via the email user interface.

12. The method of claim 11, further comprising converting the email message into a different file format when the email message is sent and before it is stored in the storage location that is selected.

13. The method of claim 12, wherein the different file format is selectable by a user of the email client and includes at least one of: PDF, .doc, .rtx, .txt, and .htm.

14. The method of claim 11, further comprising encrypting the email message when the email message is sent and before it is stored in the storage location that is selected.

15. The method of claim 12, further comprising encrypting the email message when the email message is sent and before it is stored in the storage location that is selected.

16. The method of claim 14, further comprising converting the email message into a different file format when the email message is sent and before it is stored in the storage location that is selected.

17. The method of claim 16, wherein the different file format is selectable by a user of the email client and includes at least one of: PDF, .doc, .rtx, .txt, and .htm.

18. A computer program executable on a personal computer to:
provide an email client comprising an email user interface, said email user interface including:
a TO field, wherein at least one recipient of an email message is selectable by an email client user;
a SUBJECT field, wherein a subject or the email message is identifiable by the email client user;
a message body, wherein text of the email message is entered by the email client user;
a send button; and
a STORE field, wherein a memory location the email message can he stored is identifiable and selectable by the email client user for storage of the email message when the user sends the email message by selecting the send button;
enable a user to open the email client from the personal computer;
enable a user to enter a message in a message field of the email message user interface associated with the email client;
enable a user to select at least one recipient for the email message from at least one of TO, CC, and BCC fields provided in the email user interface;
enable a user to enter a subject for the email message in a SUBJECT field provided in the email user interface;
enable a user to select a storage location via the email user interface to automatically store the email message upon sending the email message by selection of a send button on the email user interface; and
enable a user to send the email message to the at least one recipient and automatically storing the email message in the storage location that was selected via the email user interface.

19. The method of claim 18, further comprising enabling the user to select conversion of the email message into a different file format when the email message is sent and before it is stored in the storage location that is selected, wherein the different file format is selectable by the user of the email client and includes at least one of: PDF, .doc, .rtx, .txt, and .htm.

20. The method of claim 18, further comprising enabling the user to select encryption of the email message when the email message is sent and before it is stored in the storage location that is selected.
